(19) United States
(12) Patent Application Publication
(10) Pub. No.: US 2014/0197816 A1
(43) Pub. Date: Jul. 17, 2014

(54) TAP CHANGER

(71) Applicants: Jochen Von Bloh, Aachen (DE); Dieter Dohnal, Lappersdorf (DE); Karsten Viereck, Regensburg (DE)

(72) Inventors: Jochen Von Bloh, Aachen (DE); Dieter Dohnal, Lappersdorf (DE); Karsten Viereck, Regensburg (DE)

(21) Appl. No.: 13/978,717

(22) PCT Filed: Jan. 30, 2012
(86) PCT No.: PCT/EP2012/051397

§ 371 Date: Sep. 17, 2013

(30) Foreign Application Priority Data
Feb. 5, 2011 (DE) 10 2011 010 388.0

(51) Int. Cl. G05F 1/20

(52) U.S. Cl. CPC G05F 1/20
USPC 323/343

(57) ABSTRACT

The invention relates to a stepping switch for voltage control, comprising semiconductor switch elements on a variable transformer having associated regulating windings. The stepping switch has a modular design, wherein each module comprises a respective sub-winding of the regulating winding which can be activated or deactivated by semiconductor switch elements.

The invention relates to a tap changer for voltage regulation with semiconductor switching elements.

DE 22 48 166 A already describes a regulatable transformer with semiconductor switching elements. In that case the secondary winding consists of a specific number of regulating winding parts that are combined into a certain number of winding groups connected in series, wherein each winding group includes two or three regulating winding parts connected in parallel. In that case, each regulating winding part is provided with a contactless switching element. Another variant is also described in this specification, wherein the secondary winding of the transformer consists of a group of regulating winding parts connected in series and wherein each regulating winding part includes four contactless switching elements. The arrangement is such that the direction of the voltage at the terminals of the regulating winding part is reversible and also selectably the entire regulating winding part can be bridged over.

A further device for stepped switching of the secondary voltage of a transformer is known from DE 25 08 013 A. In this case as well the secondary winding is grouped into sub-windings, wherein semiconductor switching elements can similarly be provided for the switching over.

DE 197 47 712 C2 describes an arrangement of a tap changer of similar kind to a tapped transformer constructed as an autotransformer. In this case, individual winding parts are similarly provided that are connectable individually and independently of one another. Apart from fixed taps of the regulating winding, in this arrangement in addition separate winding parts can be switched on and off.

Different forms of embodiment of a further tap changer for uninterrupted load changeover are known from WO 95/27931 [U.S. Pat. No. 5,604,423], wherein similarly thyristors serve as switching elements. In that case, different winding parts of a tap winding as part of the secondary winding of the respective tapped transformer can be switched on and off by means of thyristor pairs with antiparallel connection. A method termed “discrete circle modulation”, in which the thyristors are controlled in such a manner that intermediate values of the secondary voltage result, is additionally proposed in this specification for realization of voltage regulation, which is as finely stepped as possible, with a limited number of winding taps.

In the case of the solutions known from the prior art semiconductor switching elements de facto take over the function of the mechanical selector arm in classic mechanical tap changers. Individual winding taps of the regulating windings themselves can be switched on and off by means of the semiconductor switching elements. It is also possible to subdivide the regulating winding into sub-windings which can be separately switched on.

The substantial circuit outlay and the necessary special adaptation of the semiconductor switching elements are disadvantageous in this prior art.

A further disadvantage of the prior art is that in the event of failure of individual semiconductor switching elements regulation is no longer possible or, at least, satisfactory regulation is no longer possible.

The object of the invention is to indicate a tap changer with semiconductor switching elements that is of simple construction. Moreover, it shall have a modular, expansible construction. Finally, the tap changer according to the invention shall make possible a high level of regulating reliability and accuracy even in the event of failure of individual switching elements, quasi as emergency operation.

This object is fulfilled by a tap changer with the features of the first claim. The subclaims relate to particularly advantageous developments of the invention.

The general inventive idea consists in constructing the tap changer modularly and selectively switching different sub-windings of the regulating winding on and off. The tap changer according to the invention comprises two switching subassemblies, wherein the first switching subassembly consists of a parallel connection of two switching branches and two respective semiconductor switching elements connected in series are present in each switching branch. A first sub-winding is connected between the two switching branches. The second switching subassembly consists of a parallel connection of three switching branches, wherein again two respective semiconductor switching elements connected in series are present in each switching branch. Further electrical sub-windings that—just like the first sub-winding—are magnetically coupled with the regulating winding, i.e. mounted on the respective transformer arm, are present between the first and second switching branches as well as between the second and third switching branches.

According to the invention the electrical sub-windings are differently dimensioned. If a sub-winding in a switching subassembly has a specific number of windings, the other two electrical sub-windings have winding numbers representing a multiple.

It is possible within the scope of the invention to vary the number of individual switching subassemblies which in total form the tap changer according to the invention.

A large number of voltage steps is achievable in the tap changer according to the invention with only a few components for selective switching on and off of the individual sub-windings. Moreover, a redundant generation of individual sub-voltages is possible in the tap changer according to the invention; in the case of failure—which can never be excluded in practical operation—of individual switching elements, the regulation can nevertheless substantially be continued.

The invention shall be explained in more detail in the following by way of example on the basis of drawings, in which:

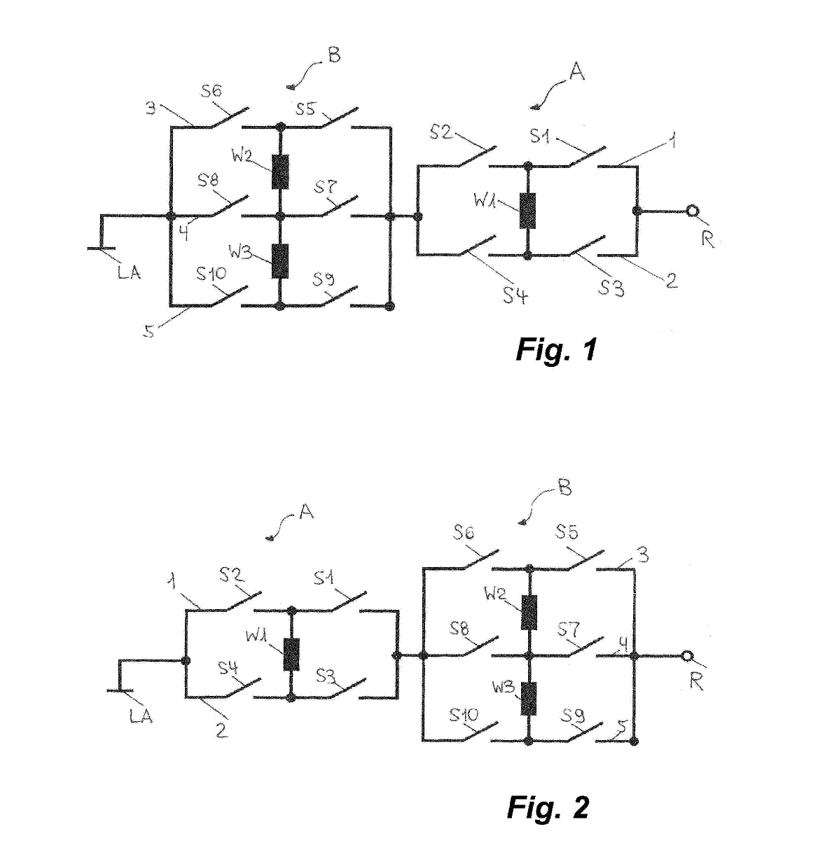

FIG. 1 shows a first form of embodiment of a tap changer according to the invention,

FIG. 2 shows a second form of embodiment,

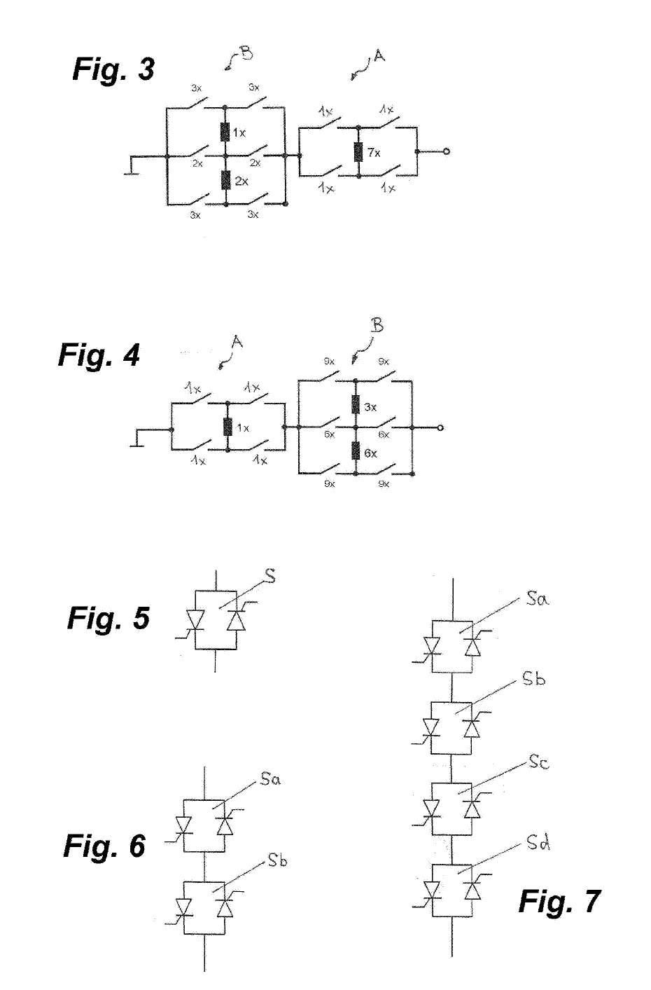

FIG. 3 shows a special dimensioning of the tap changer shown in FIG. 1,

FIG. 4 shows a special dimensioning of the tap changer shown in FIG. 2,

FIG. 5 shows a first semiconductor switching element,

FIG. 6 shows a second semiconductor switching element and

FIG. 7 shows a third semiconductor switching element.

FIG. 1 shows a first tap changer according to the invention. The tap changer shown here is arranged between the fixed, unregulated part of the winding R and the load diverter LA. It has two switching subassemblies A and B connected in series. The first switching subassembly A in turn has a parallel connection of two branches 1 and 2. Two semiconductor switching units S1, S2 in series connection with one another are provided in the first branch 1. Two further semiconductor switching elements S1, S3 in series connection with one another are provided in the parallel second branch 2. A first sub-winding W1 of the regulating winding is arranged between the two serially connected semiconductor switching units S1, S2 in the first branch 1 and the two serially connected semiconductor switching units S3, S4 in the second branch 2.

The second switching subassembly B has a parallel connection of three branches 3, 4 and 5. Two semiconductor switching units S5, S6 in series connection with one another are provided in the third branch 3, two semiconductor switching units S7, S8 in series connection with one another are provided in the fourth branch 4 and two semiconductor switching units S9, S10 in series connection with one another are provided in the fifth branch 5. The second sub-winding W2 of the regulating winding is arranged between the two serially connected semiconductor switching units S5, S6 in the third branch 3 and the two serially connected semiconductor switching units S7, S8 in the fourth branch 4 and a third sub-winding W3 is arranged between the two serially connected semiconductor switching units S7, S8 in the fourth branch 4 and the two serially connected semiconductor switching units S9, S10 in the fifth branch 5. In this form of embodiment the second switching subassembly B is electrically connected with the load diverter LA.

FIG. 2 shows a second form of embodiment of a tap changer according to the invention in which the switching subassembly A is electrically connected with the load diverter LA.

FIG. 3 shows the tap changer of FIG. 1 with a particularly advantageous dimensioning. The position of the individual components corresponds with the illustration in FIG. 1, for which reason reference numerals were dispensed with for the sake of clarity. It is shown here that the first sub-winding W1 of the switching subassembly A has seven times the winding number of the second sub-winding W2 of the switching subassembly B; similarly, the third sub-winding W3 of the switching subassembly B has twice the winding number of the second sub-winding W2. Thus, in total 21 voltage steps can be generated by selective switching on and off of the three sub-windings W1 to W3. In order to manage the corresponding switching outputs it is advantageous to construct the semiconductor switching units S5, S6, S9 and S10 as a respective series connection of here three separate semiconductor switches and the semiconductor switching units S7 and S8 as a respective series connection of here two separate semiconductor switches. Thus, in total 44 individual semiconductor switches are required.

FIG. 4 shows the tap changer of FIG. 2 with a similarly particularly advantageous dimensioning. The position of the individual components again corresponds with that of the illustration in FIG. 2, for which reason reference numerals were also dispensed with here for the sake of clarity. It is shown here that the second sub-winding W2 of the switching subassembly B has three times the winding number of the first sub-winding W1 of the switching subassembly A; the third sub-winding W3 of the switching subassembly B has six times the winding number of the first sub-winding W1. Thus, here as well in total 21 voltage steps can be generated by selective switching on and off of the three sub-windings W1 to W3. In order to manage the corresponding switching outputs it is advantageous to construct the semiconductor switching units S7 and S8 as a respective series connection of here six separate semiconductor switches and the semiconductor switching units S5, S6, S9 and S10 as a respective series connection of here nine separate semiconductor switches. Thus, in total 52 individual semiconductor switches are required.

Other dimensions of the sub-windings W1 to W3 as well as the semiconductor switching elements S1 to S10 are also possible within the scope of the invention.

FIG. 5 shows a single switch having a thyristor pair that have anti-parallel connection, as semiconductor switching unit.

FIG. 6 shows a series connection of two individual semiconductor switches Sa and Sb that can provide one of the semiconductor switching elements S1 to S10.

FIG. 7 shows a series connection of four individual semiconductor switches Sa to Sd that can similarly provide one of the semiconductor switching elements S1 to S10.

The individual semiconductor switches are here illustrated, by way of example, as thyristor pairs with anti-parallel connection; other known semiconductor switches, for example IGBTs, are also possible with the scope of the invention.

1. A tap changer for voltage regulation with semiconductor switching elements at a regulating transformer with a regulating winding, the tap changer comprising:
two switching subassemblies connected in series and each having a parallel connection of two branches,
two semiconductor switching units in series connection with one another in the first branch,
two further semiconductor switching units in series connection with one another in the parallel second branch,
a first sub-winding of the regulating winding between the two serially connected semiconductor switching units in the first branch and the two serially connected semiconductor switching units in the second branch, the second switching subassembly having a parallel connection of three branches,
two semiconductor switching units in series connection with one another in the third branch,
two semiconductor switching units in series connection with one another in the fourth branch, and
two semiconductor switching units in series connection with one another in the fifth branch,
a second sub-winding of the regulating winding between the two serially connected semiconductor switching units in the third branch and the two serially connected semiconductor switching units in the fourth branch, and
a third sub-winding between the two serially connected semiconductor switching units in the fourth branch and the two serially connected semiconductor switching units if in the fifth branch, one of the two switching subassemblies being electrically connected with the load diverter.

2. The tap changer according to claim 1, wherein the sub-windings have different winding numbers.

3. The tap changer according to claim 1, wherein at least one of the semiconductor switching units consists of a series connection of two or more individual semiconductor switches.
